(19) United States
(12) Patent Application Publication
(10) Pub. No.: US 2026/0222780 A1
(43) Pub. Date: Jul. 30, 2026

(54) Electronic Devices and Corresponding Methods for Routing Electronic Communications Among Devices

(71) Applicant: Motorola Mobility LLC, Chicago, IL (US)

(72) Inventors: Michael E. Russell, Lake Zurich, IL (US); Amit Kumar Agrawal, Bangalore (IN); Rohit Sisodia, Naperville, IL (US)

(21) Appl. No.: 19/039,628

(22) Filed: Jan. 28, 2025

(51) Int. Cl. H04W 4/80; H04B 17/318; H04W 4/02

(52) U.S. Cl. CPC H04W 4/80; H04B 17/318; H04W 4/027

(57) ABSTRACT

Embodiments of the disclosure provide electronic devices and methods for routing communications among devices. A method involves using Bluetooth Low Energy (BLE) channel sounding and supplemental measurements, such as received signal strength indication (RSSI), to determine the proximity and orientation of companion devices. The system selects the closest, user-facing device for content delivery, enhancing user experience by ensuring seamless interaction. Principal uses include managing voice and video calls in smart environments.

### BACKGROUND

### Technical Field

This disclosure relates generally to electronic devices, and more particularly to electronic devices having wireless communication devices.

### Background Art

Peer-to-peer communication facilitating seamless interaction between electronic devices has become increasingly popular. As individuals engage with a variety of interoperable devices, examples of which include smartphones, tablets, computers, smart speakers, and smart displays, the demand for efficient management of communications, including voice and video calls, has intensified. Traditional approaches often depend on sophisticated and expensive technologies, like ultra-wideband (UWB), which are generally confined to high-end products. Although these solutions are effective, they pose challenges related to cost and accessibility, making them less feasible for broad adoption.

Additionally, existing wireless protocols face limitations regarding accuracy and speed when utilized for proximity-based communication management. The imprecision in determining the relative positions of devices can result in inefficiencies and user dissatisfaction, especially in settings where multiple devices are equidistant from the user. There is thus a need for a more affordable and precise method to manage communications among devices, ensuring users can enjoy a streamlined and intuitive experience across their technological environments.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic system in accordance with one or more embodiments of the disclosure.

FIG. 2 illustrates one explanatory electronic device in accordance with one or more embodiments of the disclosure.

FIG. 3 illustrates one explanatory environment in which electronic devices and corresponding methods configured in accordance with one or more embodiments of the disclosure can operate.

FIG. 4 illustrates another explanatory environment in which electronic devices and corresponding methods configured in accordance with one or more embodiments of the disclosure can operate.

FIG. 5 illustrates one explanatory method in accordance with one or more embodiments of the disclosure.

FIG. 6 illustrates one or more method steps in accordance with one or more embodiments of the disclosure.

FIG. 7 illustrates another explanatory method in accordance with one or more embodiments of the disclosure.

FIG. 8 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, by one or more processors using a communication device, at least two locations of at least two companion electronic devices within an environment of the electronic device using at least one Bluetooth low energy (BLE) channel sounding measurement for each companion electronic device of the at least two companion electronic devices, performing, using one or more sensors, at least one supplemental measurement for the each companion electronic device of the at least two companion electronic devices, selecting, by the one or more processors, a closest, user facing companion electronic device of the at least two companion electronic devices using a combination of the at least one BLE channel sounding measurement and the at least one supplemental measurement, and causing, by the one or more processors, the communication device to deliver content to the closest, user facing companion electronic device. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to cause a BLE channel sounding enabled communication device to detect at least a first companion electronic device and a second companion electronic device operating within an environment of the electronic device and select a content reception companion electronic device from the first companion electronic device and the second companion electronic device by determining which of the first companion electronic device or the second companion electronic device has associated therewith a lesser received signal strength indication (RSSI) as described herein. The non-processor circuits may include, but are not limited to, a radio receiver, a radio transmitter, signal drivers, clock circuits, power source circuits, and user input devices.

As such, these functions may be interpreted as steps of a method to perform identifying, by one or more processors using a communication device, a plurality of companion electronic devices operating within an environment of the electronic device and determining, by the one or more processors using the communication device, at least one closer companion electronic device of the plurality of the companion electronic devices using a BLE channel sounding process. In one or more embodiments, the method comprises determining, by the one or more processors using the communication device, whether the at least one closer companion electronic device of the plurality of companion electronic devices is a front facing companion electronic device using a RSSI process and, when the at least one closer companion electronic device of the plurality of companion electronic devices is a front facing companion electronic device, causing, by the one or more processors, the communication device to deliver content to the front facing companion electronic device.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate the use of a “compute box” that is operable with one or more content presentation companion devices. In one or more embodiments, the compute box is a device designed to connect multiple electronic devices simultaneously, providing input, display, audio, and camera functionalities. This innovative device offers computational resources without being constrained by the form factor of the connected devices or accessories.

In one or more embodiments, the content presentation companion devices are deformable, having a flexible display that deforms with the device housing of the content presentation companion device. when the content presentation companion device is deformable, it becomes a flexible content presentation companion device.

Enabled by a distributed architecture system, the compute box serves as the central processing unit, akin to a mainframe computer, while each connected device acts as a flexible, wireless terminal. These terminals, known as flexible content presentation companion devices, include various content consumption devices such as fixed or flexible displays, phones, personal computers, tablets, and televisions.

In use, the compute box performs processing operations and renders content, while the companion devices present the content to users and serve as user interfaces to control the compute box's operations. This architecture allows for seamless integration and interaction among devices, enhancing the user experience by providing a centralized computing power source for diverse and flexible user interfaces.

Embodiments of the disclosure contemplate that it is advantageous to keep the form factor of the flexible content presentation companion device slim, dynamic, and deformable. Consequently, it is not always possible to have a large battery or large components such as powerful processors, large image capture devices, and so forth in such devices.

Given these limitations, the compute box provides the computing power for the flexible content presentation companion device, while the flexible content presentation companion device presents content and includes limited user interface components. Effectively, the compute box is akin to the mainframe computer of yesteryear, while each flexible content presentation companion device defines a sort of flexible, wireless terminal that serves as a primary user interface for the compute box. The compute box can perform processing operations and render content, while the flexible content presentation companion device renders that content to a user and serves as a user interface with which to control the operations of the compute box.

When using a compute box, embodiments of the disclosure contemplate that its use presents an opportunity to enhance the interaction between multiple display devices and a central computing unit. Traditional methods of linking display devices to a compute box rely on existing protocols such as Remote Desktop Protocol.sup.TM or Miracast.sup.TM, which facilitate wireless connections between the compute box as a server and the display as a client.

However, these protocols face limitations when managing cellular voice or video calls across multiple connected displays. Embodiments of the disclosure contemplate that the challenge lies in seamlessly routing and managing these calls on paired displays without user friction.

Advantageously, embodiments of the disclosure leverage BLE channel sounding and path loss determinations to address this challenge, enabling the identification and resolution of devices within a range of 0.5 to 1.0 meters. This approach allows for the use of low-cost devices, such as fitness trackers or wearables, as tags or anchors, thereby providing a cost-effective solution to the problem of call routing in a distributed architecture system.

In one or more embodiments, a method implemented in an electronic device for routing electronic communications among companion electronic devices within the environment comprises determining, by one or more processors using a communication device, at least two locations of at least two companion electronic devices using BLE channel sounding measurements. These measurements are employed for each companion electronic device to ascertain their relative positions.

Additionally, in one or more embodiments the method includes performing at least one supplemental measurement using one or more sensors for each companion electronic device. This supplemental measurement may include, but is not limited to, RSSI measurements, which help refine the accuracy of the location determination.

In one or more embodiments, the method further comprises selecting the closest, user-facing companion electronic device by combining the BLE channel sounding measurement with the supplemental measurement. Once the closest, user-facing companion electronic device is identified, the communication device is instructed to deliver content to this device, thereby ensuring efficient and seamless communication management within the electronic environment.

Advantageously, the use of BLE channel sounding allows for the determination of device proximity with reasonable accuracy, enabling the system to identify the device nearest to the user. This is particularly useful in environments where multiple devices are equidistant from the user, as this approach helps in selecting the most appropriate device for content delivery.

The supplemental measurements, such as RSSI, further refine the accuracy of the location determination, ensuring that the selected device is not only the nearest but also user-facing, thereby enhancing the user experience by providing seamless and intuitive interaction with the electronic environment. By integrating BLE channel sounding with supplemental measurements, the method addresses the limitations of existing wireless protocols in terms of accuracy and speed, offering a practical application that improves the efficiency of communication management. This approach is particularly advantageous in distributed architecture systems, where multiple devices are connected to a central compute box, as content is delivered to the most appropriate device without user intervention, thereby reducing friction and enhancing the overall user experience.

Thus, while the seamless interaction between multiple devices has become an important aspect of modern technology, and while traditional methods often rely on sophisticated technologies that are typically confined to high-end products due to their cost and complexity and create a barrier to widespread adoption, embodiments of the disclosure advantageously address these challenges by introducing a novel method for routing electronic communications among devices using BLE channel sounding. This approach leverages BLE channel sounding measurements to determine the relative positions of companion electronic devices within an environment, enabling the selection of the closest, user-facing device for content delivery.

By integrating supplemental measurements, such as RSSI, the method refines the accuracy of location determination, ensuring that the selected device is not only in proximity but also user-facing. While existing wireless protocols face significant limitations in terms of accuracy and speed, particularly when managing cellular voice or video calls across multiple connected displays, with their imprecision in determining the relative positions of devices leading to inefficiencies and user dissatisfaction, embodiments of the present disclosure offer a cost-effective solution that improves the efficiency of communication management, particularly in distributed architecture systems where multiple devices are connected to a central compute box. By delivering content to the most appropriate device without user intervention, embodiments of the disclosure reduce friction and enhances the overall user experience.

In one or more embodiments, an electronic device comprises a BLE channel sounding enabled communication device and one or more processors operable with the BLE channel sounding enabled communication device. In one or more embodiments, the one or more processors are configured to cause the BLE channel sounding enabled communication device to detect at least a first companion electronic device and a second companion electronic device operating within an environment of the electronic device.

In one or more embodiments, the processors then select a content reception companion electronic device from the first and second companion electronic devices by determining which of these devices has a lesser RSSI. This selection process ensures that the content is delivered to the most appropriate device, thereby optimizing the user experience by leveraging the proximity and orientation of the companion electronic devices relative to the user.

The arrangement of the BLE channel sounding enabled communication device with the processors advantageously allows for efficient detection and selection of the most suitable companion electronic device for content delivery. By utilizing BLE channel sounding, the system can accurately determine the proximity of companion devices, which is important in environments where multiple devices are present.

The use of RSSI as a selection criterion ensures that the device with the strongest signal, and thus likely the closest or most appropriate for content reception, is chosen. This method enhances the user experience by ensuring that content is delivered to the optimal device, reducing latency and potential errors associated with manual selection or less precise methods. Additionally, this approach provides a cost-effective alternative to more expensive technologies like UWB, making it accessible for a broader range of devices and users.

In one or more embodiments, a method in an electronic device involves identifying a plurality of companion electronic devices operating within the environment of an electronic device using one or more processors and a communication device. In one or more embodiments, the method further includes determining at least one closer companion electronic device from the plurality using a BLE channel sounding process.

Subsequently, the method involves assessing whether the closer companion electronic device is a front-facing companion electronic device by employing a RSSI process. When the closer companion electronic device is confirmed to be front-facing, in one or more embodiments the method causes the communication device to deliver content to this front-facing companion electronic device. This ensures that content is directed to the most appropriate device, enhancing user experience by leveraging the proximity and orientation of the companion electronic devices relative to the user.

Advantageously, this method provides a practical solution for efficiently managing content delivery in environments with multiple devices. By utilizing BLE channel sounding, the system can accurately determine the proximity of companion devices, which is important in environments where multiple devices are present. The use of RSSI as a criterion for determining the front-facing device ensures that content is delivered to the most appropriate device, optimizing the user experience by leveraging the proximity and orientation of the devices relative to the user.

This approach reduces latency and potential errors associated with manual selection or less precise methods, offering a cost-effective alternative to more expensive technologies like UWB. The method enhances the user experience by ensuring that content is directed to the optimal device, thereby improving the efficiency of communication management in distributed architecture systems.

Other advantages offered by embodiments of the disclosure will be described below. Still others will be obvious to those of ordinary skill in the art having the benefit of this disclosure.

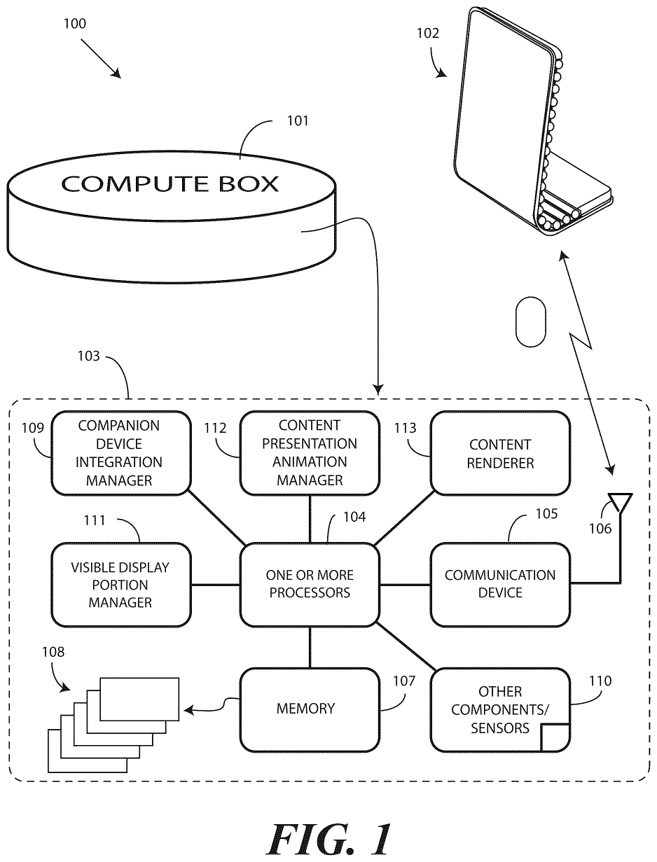

Turning now to FIG. 1, illustrated therein is one explanatory system 100 in accordance with one or more embodiments of the disclosure. In one or more embodiments, the system 100 includes a compute box 101 and a content presentation companion device, which in this illustrative embodiment happens to be flexible content presentation companion device 102 that is in communication with the compute box 101. While one compute box 101 is shown in FIG. 1, in other embodiments a single compute box 101 can be in communication with multiple content presentation companion devices, be they flexible content presentation companion devices or rigid-body content presentation companion devices.

In one or more embodiments, to allow the flexible content presentation companion device 102 to be deformable (it is shown in a stand geometric configuration in FIG. 1), there is little room for internal components, sensors, and other user interface devices that might be found, say, in a smartphone or tablet computer. Accordingly, most all computing processes for the flexible content presentation companion device 102 are performed by the compute box 101. This allows the flexible content presentation companion device 102 to remain light, bendable, and highly configurable without a loss of apparent processing power. The compute box 101 provides the processing power for the system 100, while the flexible content presentation companion device 102 serves as a content presentation device and user interface for the compute box 101.

In combination, the compute box 101 and the flexible content presentation companion device 102 can perform the functions of a conventional electronic device, such as a smartphone. However, the system 100 can work to perform the equivalent functions of any number of other devices as well, including tablet computers, gaming devices, multimedia players, and so forth. Still other types of electronic devices for which the system 100 can perform functions in accordance with one or more embodiments of the disclosure as will be readily appreciated by those of ordinary skill in the art having the benefit of this disclosure.

The compute box 101 of this illustrative embodiment is configured as a “puck” or “puc” that can be conveniently carried in a pocket, purse, backpack, or satchel. In some embodiments, the puck can be wearable. In one or more embodiments, the compute box 101 includes a device housing but has no primary display. Instead, the flexible content presentation companion device 102 functions as the primary display for the compute box 101. The flexible content presentation companion device 102 also functions as the primary user interface for the compute box 101.

In one or more embodiments, the device housing is manufactured from a rigid material such as a rigid thermoplastic, metal, or composite material, although other materials can be used. In one illustrative embodiment, the device housing is manufactured from a thermally conductive material. Illustrating by example, in one illustrative embodiment the device housing is manufactured from aluminum. Since the user holds the flexible content presentation companion device 102 and generally need not hold the compute box 101, the use of a thermally conductive material advantageously allows for thermal energy generated by heat generating electronics situated within the compute box 101 to be distributed along the surfaces of the device housing for emission into the environment for radiative cooling. Still other constructs will be obvious to those of ordinary skill in the art having the benefit of this disclosure.

Features can be incorporated into the device housing. Examples of such features include a power switch, ports for charging or connecting content presentation companion devices by wire, lanyards for wearing the puck, and so forth. User interface components such as a button, biometric sensor, or touch sensitive surface, can also be supported by the device housing to unlock the compute box 101. In other embodiments, these features may be omitted.

A block diagram schematic 103 of the compute box 101 is also shown in FIG. 1. The block diagram schematic 103 includes one or more electronics components that can be coupled to a printed circuit board assembly disposed within the device housing of the compute box 101. The electronic components can be coupled together by conductors or a bus disposed along one or more printed circuit boards.

In one or more embodiments, the compute box 101 includes one or more processors 104. In one embodiment, the one or more processors 104 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the compute box 101. Each of the application processor and the auxiliary processor(s) can be configured to process and execute executable software code to perform the various functions of the compute box 101. A storage device, such as memory 107, can optionally store the executable software code used by the one or more processors 104 during operation.

In this illustrative embodiment, the compute box 101 also includes a communication device 105 that can be configured for wired or wireless communication with one or more other devices or networks. The networks can include a wide area network, a local area network, and/or personal area network. The communication device 105 may also utilize wireless technology for communication, such as, but are not limited to, peer-to-peer or ad hoc communications such as HomeRF, Bluetooth and IEEE 802.11, and other forms of wireless communication such as infrared technology. The communication device 105 can include wireless communication circuitry, one of a receiver, a transmitter, or transceiver, and one or more antennas 106. In FIG. 1, the communication device 105 is shown as being electronically in communication with the flexible content presentation companion device 102 via signals transceived by the one or more antennas 106.

In one embodiment, the one or more processors 104 can be responsible for performing the primary functions of the compute box 101. For example, in one embodiment the one or more processors 104 comprise one or more circuits operable with one or more user interface devices of the flexible content presentation companion device 102, which can include the display of the flexible content presentation companion device 102, to present, images, video, or other presentation information to a user. The executable software code used by the one or more processors 104 can be configured as one or more modules 108 that are operable with the one or more processors 104. Such modules 108 can store instructions, control algorithms, logic steps, and so forth.

In one embodiment, the one or more processors 104 are responsible for running the operating system environment of the compute box 101. The operating system environment can include a kernel and one or more drivers, and an application service layer, and an application layer. The operating system environment can be configured as executable code operating on one or more processors or control circuits of the compute box 101. The application layer can be responsible for executing application service modules. The application service modules may support one or more applications or “apps.” The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the one or more processors 104 may generate commands or execute control operations based on information received from the various components and sensors 110. The one or more processors 104 may also generate commands or execute control operations based upon information received the flexible content presentation companion device 102. Moreover, the one or more processors 104 may process the received information alone or in combination with other data, such as the information stored in the memory 107.

The other components and sensors 110 may include a microphone, a loudspeaker, and a user interface component such as a button or touch-sensitive surface. The other components and sensors 110 can also include motion detectors, such as one or more accelerometers or gyroscopes. Still other components will be obvious to those of ordinary skill in the art having the benefit of this disclosure.

In one or more embodiments, the compute box 101 includes a companion device display integration manager 109. When another device such as the flexible content presentation companion device 102 transmits user interface controls, signals, or other information to the compute box 101, the companion device display integration manager 109 delivers that information to the one or more processors 104 for processing. Illustrating by example, when user interface control signals are redirected from the flexible content presentation companion device 102 to the compute box 101, the one or more processors 104 can perform processing operations to generate content for presentation on the flexible content presentation companion device 102.

In one or more embodiments, the one or more processors 104 can define one or more process engines. For instance, the software code stored within the memory 107 can embody program instructions and methods to operate the various functions of the compute box 101 and also to execute software or firmware applications and.

Examples of process engines shown in FIG. 1 include a visible display portion manager 111, a content presentation animation manager 112, and a content renderer 113. Such process engines can be a component of the one or more processors 104, operable with the one or more processors 104, defined by the one or more processors 104, and/or integrated into the one or more processors 104. Other configurations for these engines, including as software or firmware modules operable on the one or more processors 104, will be obvious to those of ordinary skill in the art having the benefit of this disclosure.

Where included, the process engines can be configured to determine present, alter, adapt, and manage content on the display of the flexible content presentation companion device 102. Illustrating by example, the content renderer 113 is configured to render content for presentation on a visible portion of the flexible display of the flexible content presentation companion device 102 defined by the geometric configuration of the flexible content presentation companion device 102. In the illustrative embodiment of FIG. 1, the flexible content presentation companion device 102 has been deformed into a “stand” configuration, which leaves only about two thirds of the display of the flexible content presentation companion device 102 visible to a user. The remainder of the display is situated between the surface upon which the flexible content presentation companion device 102 rests and therefore cannot be seen by a user. In one or more embodiments, the content renderer 113 would format content for presentation only on the visible portion of this display, since the “stand” portion of the display cannot be seen.

The visible display portion manager 111 receives signals from the flexible content presentation companion device 102, and in particular from one or more sensors situated in the flexible content presentation companion device 102, that indicate what the current geometric configuration and orientation in three-dimensional space of the flexible content presentation companion device 102 may be. From this information, the visible display portion manager 111 informs the content renderer 113 regarding how much of the display of the flexible content presentation companion device 102 is likely visible. Thus, the visible display portion manager 111 infers what the visible portion of the flexible content presentation companion device 102 is so that the content renderer 113 can render the content appropriately.

The content presentation animation manager 112 generates visible display area adjustment animation for content when the geometric configuration of the flexible content presentation companion device 102 changes. In one or more embodiments, the content presentation animation manager 112 continues to generate the visible display area adjustment animation so long as the geometric configuration of the flexible content presentation companion device 102 is changing. The visible display area adjustment animation causes the content to smoothly and dynamically change a first content rendering for a first visible area available on the flexible content presentation companion device 102 to a second content rendering for a second visible area available on the flexible content presentation companion device 102.

In one or more embodiments, each of these processing engines is capable of determining assessed contexts and frameworks using adjustable algorithms of context assessment employing information, data, and events. These assessments may be learned through repetitive data analysis. Alternatively, a user may employ use the flexible content presentation companion device 102 as a user interface for the compute box 101 to enter various parameters, constructs, rules, and/or paradigms that instruct or otherwise guide the process engines in detecting contextual information. The process engines can comprise an artificial neural network or other similar technology in one or more embodiments.

The inclusion of the processing engines allows the flexible content presentation companion device 102 to be operable with the compute box 101 in a “smart connect” environment. Illustrating by example, in this embodiment the compute box 101 includes a companion device display integration manager 109. The companion device display integration manager 109 can be used to communicate with the flexible content presentation companion device 102.

When coupled by a wireless connection to the flexible content presentation companion device 102 through the communication device 105 and one or more antennas 106, the flexible content presentation companion device 102 functions as the primary (and in this case, only) display for the system 100. While the compute box 101 processes content, that content is then redirected to the flexible content presentation companion device 102 for presentation to a user. In one or more embodiments, content flows from the compute box 101 to the flexible content presentation companion device 102 through the communication device 105.

It is to be understood that FIG. 1 is provided for illustrative purposes only and for illustrating components of one compute box 101 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components and still be within the scope of the present disclosure.

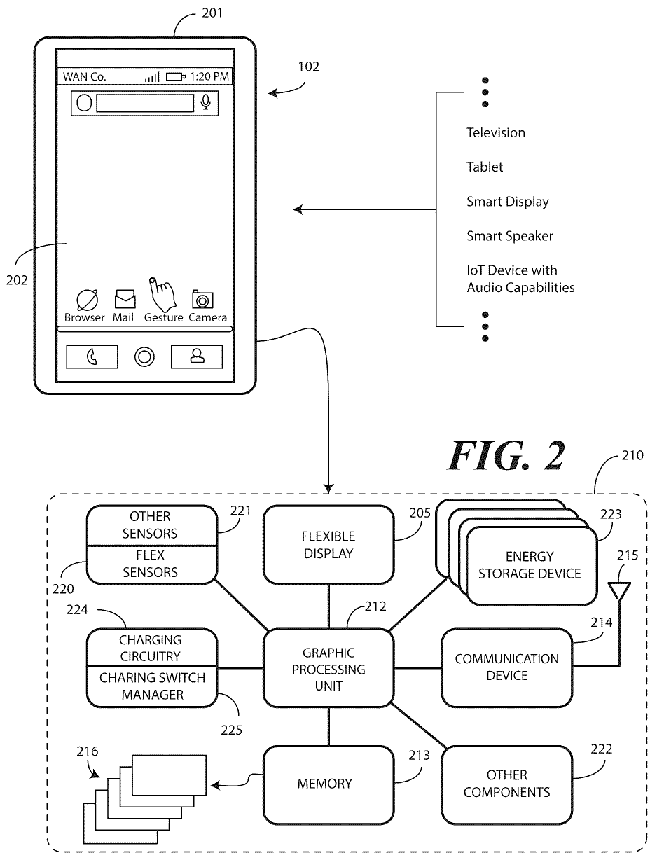

Turning now to FIG. 2, illustrated therein is additional detail regarding the flexible content presentation companion device 102 of FIG. 1. It should again be noted that the flexible content presentation companion device 102 of FIG. 1 is merely one example of a content presentation companion device that can be used with a compute box.

As indicated in FIG. 2, other content presentation companion devices include smart televisions, tablet computers, smart displays, smart speakers or Internet of Things (IoT) devices with displays and/or audio device capabilities. In an illustrative use case that will be described herein for explanatory purposes, a telephone call or videoconference call is transferred from the compute box to a content presentation companion device. Thus, in one or more embodiments the content presentation companion device will have audio capabilities and may have a display. This can be the case regardless of whether the content presentation companion device is flexible or has a rigid device housing.

The flexible content presentation companion device 102 of FIGS. 1-2 is a portable electronic device. In one or more embodiments, the flexible content presentation companion device 102 includes a deformable housing 201 that includes one or more linkage members that allows the flexible content presentation companion device 102 to be deformed by bending or folding. Advantageously, this allows the flexible content presentation companion device 102 to function as the equivalent to multiple devices depending upon the amount of deformation of the deformable housing 201.

For example, the flexible content presentation companion device 102 is shown in an unbent configuration in FIG. 2, and accordingly can function, in tandem with the compute box (101), as the equivalent of a smartphone, palm-top computer, or tablet computer. However, in other embodiments the flexible content presentation companion device 102 can be folded and can accordingly function as a table clock, content viewer, wrist loop, or auxiliary display when in a bent condition. It should be obvious to those of ordinary skill in the art having the benefit of this disclosure that the flexible content presentation companion device 102 can function with the compute box (101) as other devices as a function of its physical geometry, including as a gaming device, a media player, or other device.

This illustrative flexible content presentation companion device 102 includes a display 202, which may optionally be touch-sensitive. In one embodiment where the display 202 is touch-sensitive, the display 202 can serve as a primary user interface of the flexible content presentation companion device 102. Users can deliver user input to the display 202 of such an embodiment by delivering touch input from a finger, stylus, or other objects disposed proximately with the display.

In one embodiment, the display 202 is configured as an organic light emitting diode (OLED) display fabricated on a flexible plastic substrate. However, it should be noted that other types of displays would be obvious to those of ordinary skill in the art having the benefit of this disclosure. In one or more embodiments, an OLED is constructed on flexible plastic substrates can allow the display 202 to become flexible in one or more embodiments with various bending radii. For example, some embodiments allow bending radii of between thirty and six hundred millimeters to provide a bendable display. Other substrates allow bending radii of around five millimeters to provide a display that is foldable through active bending. Other displays can be configured to accommodate both bends and folds. In one or more embodiments the display 202 may be formed from multiple layers of flexible material such as flexible sheets of polymer or other materials.

The explanatory flexible content presentation companion device 102 of FIG. 2 also includes a deformable housing 201 that includes one or more linkage members. The linkage members allow portions of the deformable housing 201 to pivot about each linkage member so that the flexible content presentation companion device 102 becomes bendable and/or foldable. While the deformable housing 201 can be manufactured from segments of a rigid material that each bend around a corresponding hinge mechanism, such as a rigid thermoplastic or composite material, other materials can be used. Illustrating by example, the deformable housing 201 can be manufactured from a bendable material that both supports the display 202 and allows for deformation of the deformable housing 201 around the linkage members as well.

In this illustrative embodiment, the display 202 is coupled to the deformable housing 201. In one embodiment, the lower surface of the display 202, or another layer in the mechanical stack-up of the display 202, can be adhered to the deformable housing 201, or alternatively to portions of the deformable housing 201. In either embodiment, the display 202 also spans the linkage members. In one or more embodiments, the display 202 is flexible so as to deform when the deformable housing 201 bends.

Features can be incorporated into the deformable housing 201. Examples of such features include an optional image capture device or an optional speaker port, which are shown disposed on the rear side of the flexible content presentation companion device 102 in this embodiment but could be placed on the front side as well. A user interface component, which may be a button or touch sensitive surface, can also be disposed along the rear side of the deformable housing 201.

In one embodiment, the flexible content presentation companion device 102 includes one or more connectors, which can include an analog connector, a digital connector, or combinations thereof. In this illustrative embodiment, connector is an analog connector disposed on a first end, i.e., the top end, of the flexible content presentation companion device 102, while connector is a digital connector disposed on a second end opposite the first end, which is the bottom end in this embodiment.

A block diagram schematic 210 of the flexible content presentation companion device 102 is also shown in FIG. 2. The block diagram schematic 210 can be configured as a printed circuit board assembly disposed within the deformable housing 201. Various components can be electrically coupled together by conductors or a bus disposed along one or more printed circuit boards. A flexible substrate can then span the linkage members to electrically couple electronic circuits together.

In one or more embodiments, the flexible content presentation companion device 102 includes a graphic processing unit 212. The graphic processing unit 212, which can be comprises of one or more processors, receives content from a compute box (101) and renders that content on the display 202. While the graphic processing unit 212 can include one or more processors, to keep the overall size and form factor of the flexible content presentation companion device 102 light and clean, in one or more embodiments the processing power of the graphic processing unit 212 is significantly less than is the processing power of the one or more processors (104) of the compute box (101).

Still, in one or more embodiments the graphic processing unit 212 can perform limited functions of the flexible content presentation companion device 102 and can be operable with the various components of the flexible content presentation companion device 102. The graphic processing unit 212 can process and execute executable software code to perform the various functions of the flexible content presentation companion device 102 such as presenting content on the display 202. A storage device, such as memory 213, can optionally store the executable software code used by the graphic processing unit 212 during operation.

In this illustrative embodiment, the flexible content presentation companion device 102 also includes a communication device 214 that can be configured for wired or wireless communication with one or more other devices or networks. Illustrating by example, the communication device 214 can establish electronic communication with a compute box (101) as described above. The networks can include a wide area network, a local area network, and/or personal area network. The communication device 214 may also utilize wireless technology for communication, such as, but are not limited to, peer-to-peer or ad hoc communications such as HomeRF, Bluetooth and IEEE 802.11, and other forms of wireless communication such as infrared technology. The communication device 214 can include wireless communication circuitry, one of a receiver, a transmitter, or transceiver, and one or more antennas 215.

In one embodiment, the graphic processing unit 212 can be responsible for performing the primary functions of the flexible content presentation companion device 102. For example, in one embodiment the graphic processing unit 212 comprise one or more circuits operable with one or more user interface devices, which can include the display 202, to present, images, video, or other presentation information received from a compute box (101) to a user. The executable software code used by the graphic processing unit 212 can be configured as one or more modules 216 that are operable with the graphic processing unit 212. Such modules 216 can store instructions, control algorithms, logic steps, and so forth.

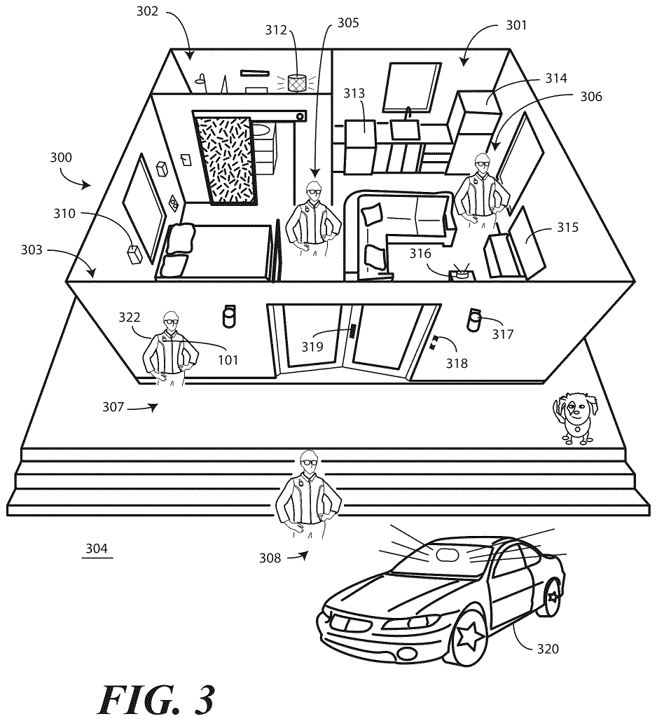

In one embodiment, the flexible content presentation companion device 102 includes one or more flex sensors 220 that are operable to detect a bending operation that causes the deformable housing 201 to deform, thereby transforming the flexible content presentation companion device 102 into a deformed geometry, such as that shown in FIGS. 3-5. The inclusion of flex sensors 220 is optional, and in some embodiment flex sensors 220 will not be included. Where flex sensors 220 are not included and device operation is a function of the amount of deformation of the deformable housing 201, the user can deliver input to the display 202 of the flexible content presentation companion device 102 to inform the compute box (101) to the fact that the one or more bends are present through the user interface or by other techniques.

In one embodiment, the flex sensors 220 comprise passive resistive devices manufactured from a material with an impedance that changes when the material is bent, deformed, or flexed. By detecting changes in the impedance as a function of resistance, the one or more flex sensors 220 detect bending of the deformable housing 201. In one or more embodiments, each flex sensor 220 comprises a bi-directional flex sensor that can detect flexing or bending in two directions. In one embodiment, the one or more flex sensors 220 have an impedance that increases in an amount that is proportional with the amount it is deformed or bent.

In one embodiment, each flex sensor 220 is manufactured from a series of layers combined together in a stacked structure. In one embodiment, at least one layer is conductive, and is manufactured from a metal foil such as copper. A resistive material provides another layer. These layers can be adhesively coupled together in one or more embodiments. The resistive material can be manufactured from a variety of partially conductive materials, including paper-based materials, plastic-based materials, metallic materials, and textile-based materials. In one embodiment, a thermoplastic such as polyethylene can be impregnated with carbon or metal so as to be partially conductive, while at the same time being flexible.

In one embodiment, the resistive layer is sandwiched between two conductive layers. Electrical current flows into one conductive layer, through the resistive layer, and out of the other conductive layer. As the flex sensor 220 bends, the impedance of the resistive layer changes, thereby altering the flow of current for a given voltage. Taps can be added along each flex sensor 220 to determine other information, including the amount of bending, the direction of bending, and so forth. The flex sensor 220 can further be driven by time-varying signals to increase the amount of information obtained from the flex sensor 220 as well. While a multi-layered device as a flex sensor 220 is one configuration suitable for detecting at least a bending operation occurring to deform the flexible content presentation companion device 102 and a geometry of the flexible content presentation companion device 102 after the bending operation, others can be used as well. Other types of flex sensors 220 will be obvious to those of ordinary skill in the art having the benefit of this disclosure.

The one or more other sensors 221 may include a microphone, an earpiece speaker, a second loudspeaker (disposed beneath speaker port 205), and a user interface component such as a button or touch-sensitive surface. The one or more other sensors 221 may include one or more of an accelerometer, gyroscope, image capture device, and/or display touch sensors to determine whether the flexible content presentation companion device 102 is being held on the base side or flip side in a portrait mode.

The one or more other sensors 221 may also include key selection sensors, proximity sensors, a touch pad sensor, a touch screen sensor, a capacitive touch sensor, and one or more switches. Touch sensors may be used to indicate whether any of the user actuation targets present on the display 202 are being actuated. Alternatively, touch sensors disposed in the flexible content presentation companion device 102 can be used to determine whether the flexible content presentation companion device 102 is being touched at side edges or major faces of the deformable housing 201. The touch sensors can include surface and/or housing capacitive sensors in one embodiment. The other sensors 221 can also include audio sensors and video sensors (such as a camera).

The other sensors 221 can also include motion detectors, such as one or more accelerometers or gyroscopes. For example, an accelerometer may be embedded in the electronic circuitry of the flexible content presentation companion device 102 to show vertical orientation, constant tilt and/or whether the flexible content presentation companion device 102 is stationary. A gyroscope can be used in a similar fashion.

Other components 222 of the flexible content presentation companion device 102 can include output components such as video outputs, audio outputs, and/or mechanical outputs. Examples of output components include audio outputs such as speaker port, earpiece speaker, or other alarms and/or buzzers and/or a mechanical output component such as vibrating or motion-based mechanisms. Still other components will be obvious to those of ordinary skill in the art having the benefit of this disclosure.

In one or more embodiments, the flexible content presentation companion device 102 comprises a plurality of energy storage devices 223. In one or more embodiments, the plurality of energy storage devices 223 include an energy storage device situated in each linkage member.

Each energy storage device of the plurality of energy storage devices 223 can take a variety of forms. In an illustrative embodiment, each energy storage device of the plurality of energy storage devices 223 can comprise an electrochemical cell. For instance, the plurality of energy storage devices 223 can each comprise a lithium-ion, lithium-polymer, or other type of rechargeable cell. Other examples of energy storage devices suitable for use with embodiments of the disclosure will be obvious to those of ordinary skill in the art having the benefit of this disclosure. For instance, in other embodiments the plurality of energy storage devices 223 may be a supercapacitor, and so forth.

Charging circuitry 224 can be included to selectively individual, subsets, or all of the plurality of energy storage devices 223 when depleted. In one or more embodiments, the charging circuitry 224 comprises a charging node that is coupled to each energy storage device of the plurality of energy storage devices 223.

In one or more embodiments, the charging circuitry 224 includes a switch 225 that is electrically coupled between the conductor coupling the plurality of energy storage devices 223. Opening the switch 225 disconnects the conductor from the plurality of energy storage devices 223, while closing the switch couples the plurality of energy storage devices 223 to the components of the block diagram schematic 210.

It is to be understood that FIG. 2 is provided for illustrative purposes only and for illustrating components of one flexible content presentation companion device 102 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components and still be within the scope of the present disclosure.

A user can perform a bending operation upon the flexible content presentation companion device 102. For example, a user can apply force at the first end and the second end of the flexible content presentation companion device 102 to pivot portions of the deformable housing 201 relative to other portions of the deformable housing 201. This method of deforming the deformable housing 201 allows the user to simply and quickly bend the flexible content presentation companion device 102 into a desired shape.

In other embodiments, rather than relying upon the manual application of force, the flexible content presentation companion device 102 can include a mechanical actuator to deform the deformable housing 201 around the linkage members. For example, a motor or other mechanical actuator can be operable with structural components to deform the deformable housing 201 around the linkage members to predetermined angles or geometric alignments in one or more embodiments. The inclusion of a mechanical actuator allows a precise bend angle to be repeatedly achieved without the user having to make adjustments. However, as the inclusion of a mechanical actuator can increase cost, in other embodiments this component will be omitted.

It should be noted that in one or more embodiments, the display 202 has a compliance coefficient that can be used advantageously to help counter the bending operation. Illustrating by example, when the bending operation transforms the flexible content presentation companion device 102 to a bent configuration in one or more embodiments the mechanical layers of the display 202 are loaded by the bending operation and work to bias portions of the deformable housing 201 back to the open position of FIG. 2.

Moreover, in one or more embodiments a thin stainless-steel plate (approximately 0.04 millimeters in thickness) forms one layer of the display 202 and will increase the loading. This mechanical loading of the layers of the display 202 can be used to help the user transform the flexible content presentation companion device 102 from folded or partially folded configurations to unfolded configurations in one or more embodiments. The modulus of the display 202 can range from 40-300 giga-Pascals in one or more embodiments.

Embodiments of the disclosure involve the execution of a method for routing incoming cellular voice or video calls to the most appropriate display device connected to a compute box, utilizing BLE channel sounding. In one or more embodiments, this method begins by determining the proximity of various paired display devices using BLE channel sounding measurements and RSSI\path loss calculations.

In one or more embodiments, the compute box, upon receiving a call, identifies the display device that is paired and has the user profile active for whom the call is intended. If the conditions are met, the compute box launches the calling screen on the selected display device, ensuring a seamless transition of the call to the user.

Additionally, the system can wake up the display if it is in a sleep state and activate the ringer to alert the user of the incoming call. This approach not only enhances the user experience by providing a frictionless call management system but also leverages cost-effective BLE technology, making it accessible for a broader range of devices. The solution can be extended to other applications, such as music streaming or multiplayer gaming, where content needs to be directed to the most suitable device within a connected environment

Turning now to FIG. 3, illustrated therein is one environment in which such a method can be performed. The environment illustrated in FIG. 3 is a dwelling, which is a house 300 in this explanatory embodiment. In other embodiments, the environment could be a building, condominium, apartment complex, or other type of structure. In still other embodiments, the environment can be outdoors.

Also illustrated in FIG. 3 is one explanatory system suitable for using an electronic device 101 configured in accordance with one or more embodiments of the disclosure to cause a BLE channel sounding enabled communication device to detect at least a first companion electronic device and a second companion electronic device operating within an environment of the electronic device and select a content reception companion electronic device from the first companion electronic device and the second companion electronic device by determining which of the first companion electronic device or the second companion electronic device has associated therewith a lesser RSSI.

In the illustrative embodiment of FIG. 3, the house 300 includes walls defining both indoor and outdoor areas. The house 300 includes various structural elements and spaces house companion electronic devices that can be used with the electronic device 101 to transfer calls or other content for consumption of by an authorized user 322 of the electronic device 101.

The interior of the house 300 represents the enclosed spaces within the structure. The interior includes multiple rooms and areas where electronic devices may be located. The bathroom 302 is one explanatory room within the interior. The bedroom 303 is another room within the interior of the house 300. The exterior 304 of the house 300 represents the outdoor areas surrounding the structure. The hallway is a passage within the interior that connects different rooms. The main room is a central area within the interior. The front porch is a transitional area between the interior and the exterior. The yard is an open space within the exterior.

As shown in FIG. 3, an authorized user 322 has configured the electronic device 101 to be a wearable electronic device and is wearing the electronic device 101 on a jacket. The authorized user 322 is able to move from a first location 305 centrally situated within the house 300, a second location 306 situated within the house 300, a first location 307 outside the house 300, a second location 308 situated outside the house 300, and so forth.

In one or more embodiments, the electronic device 101 has a companion electronic device mapping manager that determines the location of each companion electronic device situated within the house 300 that is operable with the electronic device 101 as the authorized user 322 moves between these locations 305,306,307,308. Illustrating by example, in one or more embodiments the companion electronic device mapping manager determines at least two locations of at least two companion electronic devices within the house 300 using at least one BLE channel sounding measurement for each companion electronic device of the at least two companion electronic devices. In one or more embodiments, the companion electronic device mapping manager also performs at least one supplemental measurement for each companion electronic device to determine (1) which companion electronic device is closest to the authorized user 322 and (2) which companion electronic device the authorized user 322 is facing.

Upon doing so, the companion electronic device mapping manager can select a closest, user facing companion electronic device of the at least two companion electronic devices using a combination of the at least one BLE channel sounding measurement and the at least one supplemental measurement. One or more processors of the electronic device 101 can then cause the communication device to deliver content to the closest, user facing companion electronic device. Advantageously, when the authorized user 322 receives a call, the electronic device 101 automatically directs the call to the closest, user facing companion electronic device in the house so that the call can be conveniently answered.

As will be described below, in one or more embodiments the system aims to determine the precise locations and relative positions of companion electronic devices within an environment, such as the smart home, using a combination of BLE channel sounding and RSSI measurements. The illustrative companion electronic devices of FIG. 1 are situated within a main room 301, a bathroom 302, a bedroom 303, and an exterior 304 of the house 300. These companion electronic devices include smart lights 310,312,317 a smart dishwasher 313, a smart refrigerator 314, a smart television 315, a router 316, a smart doorbell 318, a smart lock 319, and a car 320 with an onboard entertainment system. Since many of these IoT things have audio and video capabilities, the electronic device 101 may choose any suitable such device that is a closest, user facing companion electronic device to redirect communications.

In one or more embodiments, a companion electronic device mapping manager operating in the electronic device implements a method that includes determining, by one or more processors using a communication device, at least two locations of at least two companion electronic devices within an environment of the electronic device using at least one BLE channel sounding measurement for each companion electronic device of the at least two companion electronic devices. Illustrating by example, when the authorized user 322 is standing in the main room 301, the companion electronic device mapping manager may locate the smart refrigerator 314, the smart dishwasher 313, and the smart television 315 using BLE channel sounding since these devices each comprise BLE sounding enabled companion electronic devices.

In one or more embodiments the companion electronic device mapping manager also performs, using one or more sensors, at least one supplemental measurement for the each companion electronic device of the at least two companion electronic devices. In one or more embodiments, the at least one supplemental measurement comprises at least one RSSI measurement of one or more communication signals received by the communication device from the at least two companion electronic devices.

To understand why the combination of BLE channel sounding and RSSI is preferred for locating the closest, user-facing companion electronic device, it is well to unpack these concepts in simple terms. BLE is a wireless communication technology that allows devices to exchange data over short distances. Channel sounding is a technique used to measure the time required for a signal to travel from one device to another and back. This is known as the “round-trip time.” By measuring this time, the system can estimate the distance between devices.

One issue with using BLE channel sounding alone is that it might not provide a high level of precision, especially in environments with obstacles or interference. RSSI is a measure of the power level that a device receives from a signal sent by another device. In simple terms, this measure indicates the strength of the signal. Generally, a stronger signal suggests that the device is in closer proximity. However, RSSI can be influenced by various factors such as walls, furniture, or even people, which can block or weaken the signal.

By using both BLE channel sounding and RSSI together, the system can more accurately determine which device is closest and facing the user. Here's why this combination is effective:

First, BLE channel sounding provides a rough estimate of distance, while RSSI helps refine this estimate by considering signal strength. Together, they offer a more reliable way to determine proximity.

Next, each method has its limitations individually. BLE channel sounding might not be precise on its own, and RSSI can be affected by obstacles. By combining them, the system can compensate for these weaknesses, leading to improved accuracy.

Moreover, the combination helps not only in finding the closest device but also in determining which device is facing the user. This is important for ensuring that content, like a phone call or video, is delivered to the most appropriate device. In the context of FIG. 3, this combination allows the system to efficiently manage and route communications to the right device in a smart home environment, enhancing the user experience by ensuring seamless interaction with the closest, user-facing device.

Once the closest, user facing companion electronic device is found, in one or more embodiments the one or more processors of the electronic device 101 cause the communication device to deliver content to the closest, user facing companion electronic device. Thus, when the authorized user 322 is in location 306, the closest, user facing companion electronic device is the smart television 315. Thus, when standing in this location 306 as shown in FIG. 3, a call received by the electronic device 101 would be quickly and automatically routed to the smart television 315, which is within the line of sight of the authorized user 322 of the electronic device 101.

In one or more embodiments, selection of the closest, user facing companion electronic device comprises choosing a companion electronic device of the at least two companion electronic devices having a lesser path loss, as indicated by the RSSI measurement, than another companion electronic device of the at least two companion electronic devices. In one or more embodiments. a path loss of the companion electronic device is at least ten decibels lower than another path loss of the another companion electronic device when it is selected.

While RSSI can be a primary supplemental measurement used with the BLE channel sounding, embodiments of the disclosure contemplate that other supplemental measurements can be used as well. Illustrating by example, in one or more embodiments the at least one supplemental measurement comprises a body detection measurement detecting whether the electronic device is experiencing a bodily worn condition.

The electronic device 101 can determine if the device is being worn on the body using various sensors and techniques. In one or more embodiments, accelerometers and gyroscopes can be used for this purpose, as these sensors can detect movement and orientation. When the electronic device 101 is worn as shown in FIG. 3, the electronic device 101 experiences particular patterns of motion, such as the swinging of an arm or the subtle movements of walking. By analyzing these patterns, the device can determine if the device is being worn.

This method is effective in detecting dynamic activities and can provide real-time feedback. The method also operates with relatively low power consumption, making the method suitable for wearable devices that need to conserve battery life.

In other embodiments, proximity sensors can be used to detect the bodily worn condition. These sensors can detect how close the device is to the body. For instance, if the device is in a pocket or on a wrist, the proximity sensor can detect the closeness of the skin or clothing. Proximity sensors are useful for detecting when the device is in contact with the body, which can help in reducing false positives when the device is simply being carried.

Temperature sensors can be used to measure the temperature of the device's surroundings. When worn, the device is likely to be at a temperature closer to that of the human body. Temperature sensors can provide a simple and effective way to confirm that the device is in contact with the body, especially in environments where the ambient temperature is significantly different from body temperature.

Capacitive touch sensors can detect the presence of a body part, like a finger or wrist, by measuring changes in capacitance. Capacitive sensors are highly sensitive and can detect even slight touches, making them useful for confirming contact with the skin.

Optical sensors use light to detect the presence of the skin. They can be used to measure heart rate or other biometric data, which also confirms that the device is being worn. Optical sensors can provide additional health-related data, such as heart rate, which can be beneficial for fitness tracking and health monitoring.

Each of these techniques offers distinct advantages, and they can be used alone or in combination to improve accuracy and reliability. By using multiple sensors, the device can more accurately determine if the device is being worn, which is important for features that depend on body contact, such as health monitoring or personalized notifications. Other techniques for detecting a bodily worn condition will be obvious to those of ordinary skill in the art having the benefit of this disclosure.

In the context of FIG. 3, as an alternative to RSSI as a supplemental measurement, the combination of BLE channel sounding and the detection of a bodily worn condition can be used to accurately determine which electronic device is closest to and facing the user. As noted above, BLE channel sounding can estimate the distance between devices. However, when used independently, BLE channel sounding might not achieve high precision, particularly in environments with obstacles like walls or furniture.

Detecting a bodily worn condition can involve using sensors to determine if a device is being worn on the body, such as on a wrist or in a pocket. Sensors like accelerometers, gyroscopes, or proximity sensors can detect movement patterns or closeness to the body, helping to confirm that the device is being worn.

Their combination offers improved accuracy. BLE channel sounding gives a rough estimate of distance, while detecting a bodily worn condition helps refine this estimate. When the authorized user's body is between a device and the electronic device 101, it is not front facing. Accordingly, together, they provide a more reliable way to determine which device is closest to the user. Thus, this combination not only helps find the closest device but also ensures that the device is facing the user. This is important for delivering content, like a phone call or video, to the most appropriate device. In summary, using both BLE channel sounding and bodily worn condition detection allows the system to more accurately and reliably determine which device is closest to and facing the user, enhancing the user experience by ensuring seamless interaction with the right device.

Of course, BLE channel sounding, RSSI, and whether the electronic device 101 is experiencing a bodily worn condition can be combined. Illustrating by example, in one or more embodiments when a bodily worn condition is detected, the one or more processors of the electronic device 101 adjust the RSSI measurement.

When an electronic device, like electronic device 101 in FIG. 3 is worn on the body, the human body can interfere with the signal. This interference can cause the RSSI measurement to be less accurate. One reason why is that the human body can block or absorb some of the signal, which can make the signal appear weaker than the signal truly is. This occurs because the body is composed of water and other materials that can absorb radio waves.

The body can also reflect signals, causing them to take longer paths to reach the device. This can lead to variations in the signal strength that the device measures.

When a device is worn on the body, the device is in close proximity to the body, which can cause the signal to be stronger or weaker depending on the position and orientation of the device relative to the signal source.

Because of these factors, the RSSI measurement might not accurately reflect the true distance or position of the device relative to other devices. When the device is in a bodily worn condition, adjustments to the RSSI measurement are necessary to account for these interferences. This helps ensure that the device can still accurately determine its proximity to other devices, even when worn on the body. Adjusting the RSSI measurement helps improve the accuracy of determining which device is closest and facing the user, which is important for the system to function effectively.

In still other embodiments, the at least one supplemental measurement comprises a motion measurement detecting whether the electronic device is in motion within the environment. In one or more embodiments, the one or more processors of electronic device 101 filter one or both of the at least one BLE channel sounding measurement or the at least one supplemental measurement when the electronic device is in motion within the environment. When an electronic device is in motion, the movement can affect the accuracy of certain measurements used to determine the proximity and orientation of nearby devices.

Illustrating by example, when a device is moving, the signal path used in the BLE channel sounding process can change rapidly, leading to fluctuations in the measurement. These fluctuations can make the distance estimation less reliable.

RSSI assists in determining the strength of the signal, which can suggest the proximity of the device. However, RSSI can be influenced by movement because the signal strength may change as the device moves through various environments, encountering obstacles like walls or furniture that can block or reflect signals.

Filtering helps smooth out the rapid changes in measurements caused by motion. This means the system can provide a more stable and accurate estimate of the device's position relative to others. By filtering out the noise and fluctuations caused by movement, the system can better determine which device is closest and facing the user. This plays an important role in ensuring that content, like a phone call or video, is delivered to the most appropriate device.

Embodiments of the disclosure contemplate that not all devices capable of receiving communications from the electronic device 101 will be preferred devices of the authorized user 322. Illustrating by example, even if the smart dishwasher 313 has a video screen and audio output, the authorized user 322 may not want to have a videoconference with her grandmother on a dishwasher. Consequently, embodiments of the disclosure contemplate that the authorized user 322 will set up profiles only on certain devices that she wants to use for consuming content. Accordingly, in one or more embodiments the one or more processors of electronic device 101 determine, prior to transferring any content, whether a user profile associated with the content is active on the closest, user facing companion electronic device. In one or more embodiments, the causing delivery of the content occurs only when the user profile associated with the content is active on the closest, user facing companion electronic device.

In the illustrative example of FIG. 3, the authorized user 322 has set up a user profile on the smart television 315 for videoconferences because it has a display, and the videoconference comprises pictorial or video content. Accordingly, when the authorized user 322 is at location 306 the electronic device 101 would transfer a videoconference call to the smart television 315.

However, embodiments of the disclosure contemplate that sometimes audio and video can be split. Illustrating by example, if the authorized user 322 is wearing wireless earbuds and the content comprises pictorial or video content, it might be sent to the smart television 315 while audio content associated with the pictorial or video content is delivered to a companion electronic device other than the closest, user facing companion electronic device, which would be the wireless earbuds in this example.

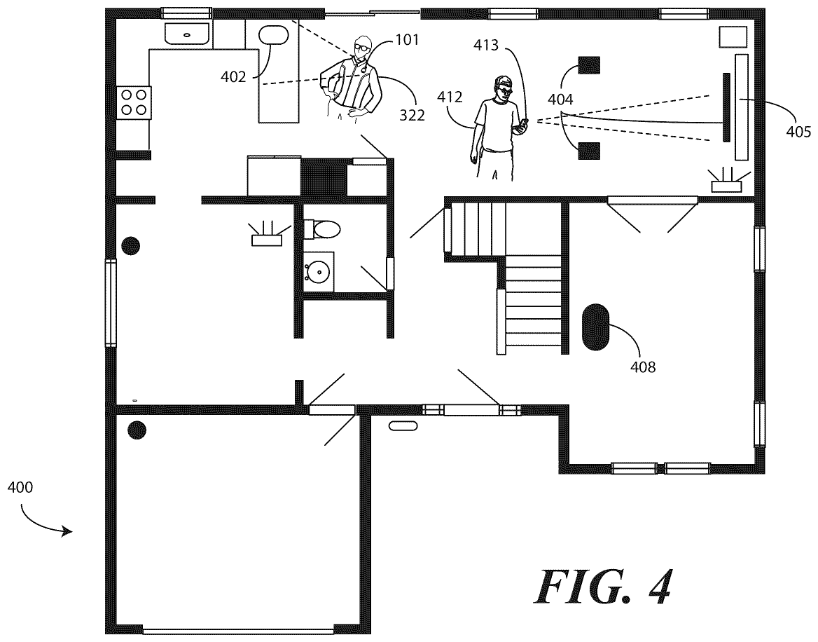

Turning now to FIG. 4, illustrated therein is another system configured in accordance with one or more embodiments of the disclosure. As illustrated in FIG. 4, one version of a residential setting, labeled as home environment 400, has situated therein devices equipped with BLE technology for determining locations and managing call routing. This illustrative home environment 400 is divided into several distinct areas, including a kitchen, an office, a living room, and a family room.

The authorized user 322 of electronic device 101 and another user 412 of another electronic device 413 are situated within the home environment 400. A first display device 405 is positioned in the family room, while a second display device 402 is located in the kitchen.

A third display device 408 is in the living room, while a smart speaker 404 is placed in the family room. Electronic device 101, worn by authorized user 322, is in the kitchen, and the other electronic device 413, which is carried by the other user 412, is in the family room.

Each electronic device 101,413 is capable of determining the positions of each display device, user device, and the smart speaker within the home environment 400, relative to its own location, by utilizing a combination of BLE channel sounding and at least one supplemental measurement. Illustrating by example, each electronic device 101,413 comprises a BLE channel sounding enabled communication device and one or more processors operable with the BLE channel sounding enabled communication device as previously described.

In one or more embodiments the one or more processors cause the BLE channel sounding enabled communication device to detect at least a first companion electronic device, e.g., display device 405, and a second companion electronic device, e.g., display device 402, operating within the home environment 400 of the electronic devices 101,413. In one or more embodiments, the one or more processors then select a content reception companion electronic device from the first companion electronic device and the second companion electronic device by determining which of the first companion electronic device or the second companion electronic device has associated therewith a lesser RSSI.

Due to the way that authorized user 322 is facing, electronic device 101 would select display device 402. Similarly, due to the way that the other user 412 is standing, electronic device 413 would choose display device 405. In one or more embodiments, the one or more processors of each electronic device 101,413 cause their corresponding BLE channel sounding enabled communication device to transmit content to the content reception companion electronic device in response to selecting the content reception companion electronic device.

In one or more embodiments, detection of the first companion electronic device and the second companion electronic device occurs in response to the electronic device receiving the content from a remote electronic device across a network. Thus, when either electronic device 101 or the other electronic device 413 received a call from another electronic device from across a network, the combined BLE channel sounding/RSSI detection can begin in one or more embodiments.

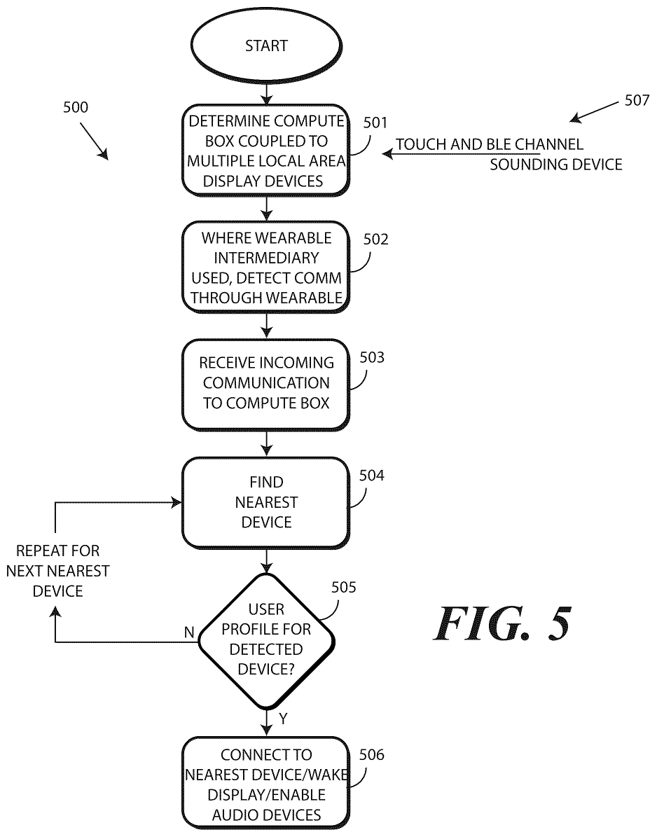

Turning now to FIG. 5, illustrated therein is one explanatory method 500 illustrating the operation described above with reference to FIGS. 3-4. Beginning at step 501, the method identifies, by one or more processors using a communication device, a plurality of companion electronic devices operating within an environment of the electronic device. In one or more embodiments, at least one of the identified companion electronic devices comprises a BLE-equipped, touch sensitive device 507.

At step 502, the method 500 looks for wearable intermediary devices that may be in used. Illustrating by example, if a user is using wearable earbuds to receive audio from a compute box, they would be detected at step 502.

At step 503, an incoming communication is received by the compute box. If, for example, a videoconference or telephone call was directed to the compute box from a remote electronic device across a network, it would be received at step 503.

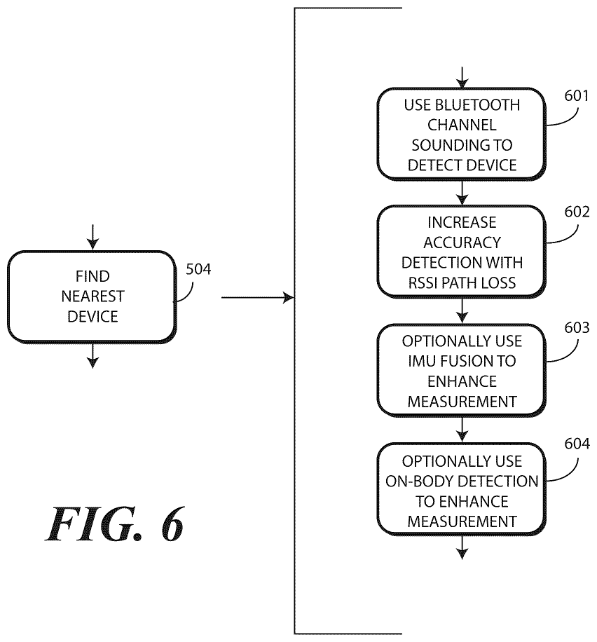

At step 504, the method 500 determines possible companion electronic devices to which the communication received at step 503 can be transferred for consumption by the user of the compute box. Turning briefly to FIG. 6, illustrated therein are some of the sub-steps that can occur at step 504.

In one or more embodiments, step 504 comprises, at sub-step 601, determining, by the one or more processors using the communication device, at least one closer companion electronic device of the plurality of the companion electronic devices using a BLE channel sounding process. In one or more embodiments, step 504 also comprises, at sub-step 602, determining, by the one or more processors using the communication device, whether the at least one closer companion electronic device of the plurality of companion electronic devices is a front facing companion electronic device using a RSSI process.

As noted above, step 504 can also comprise determining, using one or more sensors at step 603, whether the electronic device is moving. In one or more embodiments, when the electronic device is moving, sub-step 603 comprises filtering, by the one or more processors, the calculations of the RSSI process.

Sub-step 604 can determine whether the compute box is in a bodily worn condition. In one or more embodiments, step 504 comprises, at sub-step 604 when the electronic device is in a bodily worn condition, adjusting calculations of the RSSI process used to determine whether the at least one closer companion electronic device of the plurality of companion electronic devices is the front facing companion electronic device.

Turning now back to FIG. 5, in one or more embodiments decision 505 determines whether a user profile associated with the content is active on the front facing companion electronic device. Step 504 and decision 505 can repeat for all detected companion electronic devices within the environment.

Step 506 comprises, when the at least one closer companion electronic device of the plurality of companion electronic devices is a front facing companion electronic device, causing, by the one or more processors, the communication device to deliver content to the front facing companion electronic device. In one or more embodiments, this causing only occurs when a user profile associated with the content is active on the front facing companion electronic device.

In one or more embodiments, the causing only occurs when the front facing companion electronic device is a closest, front facing companion electronic device of the plurality of companion electronic devices. In one or more embodiments, step 506 comprises causing, by the one or more processors using the communication device, the front facing companion electronic device to wake from a sleep state and to deliver an alert indicating the content is being delivered to the front facing companion electronic device.

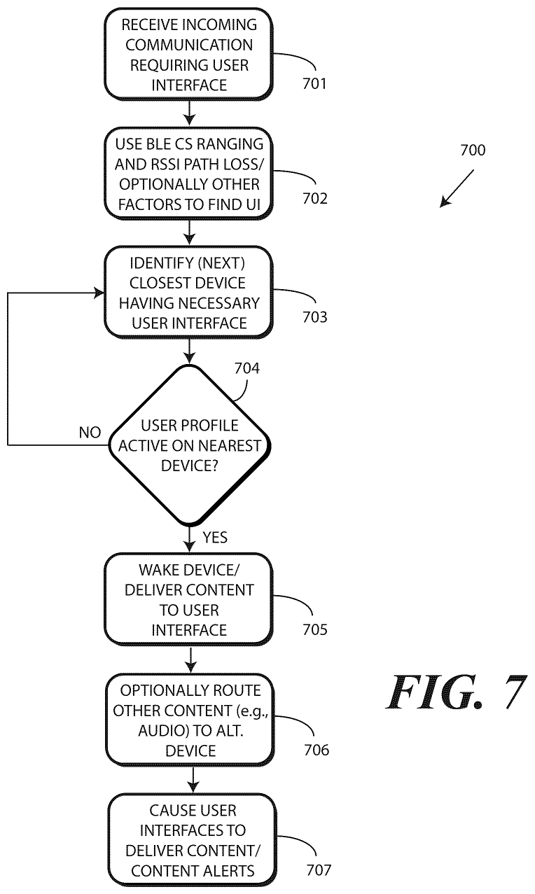

Turning now to FIG. 7, illustrated therein is another method 700 in accordance with one or more embodiments of the disclosure. Beginning at step 701, an incoming communication is received from a remote electronic device across a network. At step 702, in response to the incoming communication in one or more embodiments, the locations of at least two companion electronic devices are determined.

In one or more embodiments step 702 comprises determining, by one or more processors using a communication device, at least two locations of at least two companion electronic devices within an environment of the electronic device using at least one BLE channel sounding measurement for each companion electronic device of the at least two companion electronic devices and performing, using one or more sensors, at least one supplemental measurement for the each companion electronic device of the at least two companion electronic devices. In one or more embodiments, the at least two companion electronic devices comprise BLE sounding enabled companion electronic devices.

In one or more embodiments, the at least one supplemental measurement comprises at least one RSSI measurement of one or more communication signals received by the communication device from the at least two companion electronic devices. In one or more embodiments, the at least one supplemental measurement comprises a body detection measurement detecting whether the electronic device is experiencing a bodily worn condition. In one or more embodiments, the at least one supplemental measurement comprises a motion measurement detecting whether the electronic device is in motion within the environment. As described above, these supplemental measurements can be used in combination. Step 703 then identifies the closest device having the necessary user interface for the content to be transferred.

Optional decision 704 determines whether a user profile associated with the content is active on the detected companion electronic device. Step 705 and decision 704 can repeat for all detected companion electronic devices within the environment.

Step 705 then selects, by the one or more processors, a closest, user facing companion electronic device of the at least two companion electronic devices using a combination of the at least one BLE channel sounding measurement and the at least one supplemental measurement and causes, by the one or more processors, the communication device to deliver content to the closest, user facing companion electronic device. In one or more embodiments, the selecting the closest, user facing companion electronic device comprises choosing a companion electronic device of the at least two companion electronic devices having a lesser path loss, as indicated by the RSSI measurement, than another companion electronic device of the at least two companion electronic devices.

Illustrating by example, in one or more embodiments a path loss of the companion electronic device is at least ten decibels lower than another path loss of the another companion electronic device. As noted above, step 705 can comprise adjusting the RSSI measurement when the electronic device is experiencing a bodily worn condition and/or filtering, by the one or more processors, one or both of the at least one BLE channel sounding measurement or the at least one supplemental measurement when the electronic device is in motion within the environment. Step 705 can also comprise waking the closest, user facing companion electronic device.

In one or more embodiments, where an intermediary device was detected, such as earbuds, optional step 706 can comprise delivering audio content associated with the pictorial or video content delivered to the closest, user facing companion electronic device to a companion electronic device other than the closest, user facing companion electronic device. Video may be delivered to the closest, user facing companion electronic device, for example, while audio is delivered to the earbuds in an example. The closest, user facing companion electronic device can be caused to present notifications or other alerts to identify the fact that it has been selected ats step 707 §.

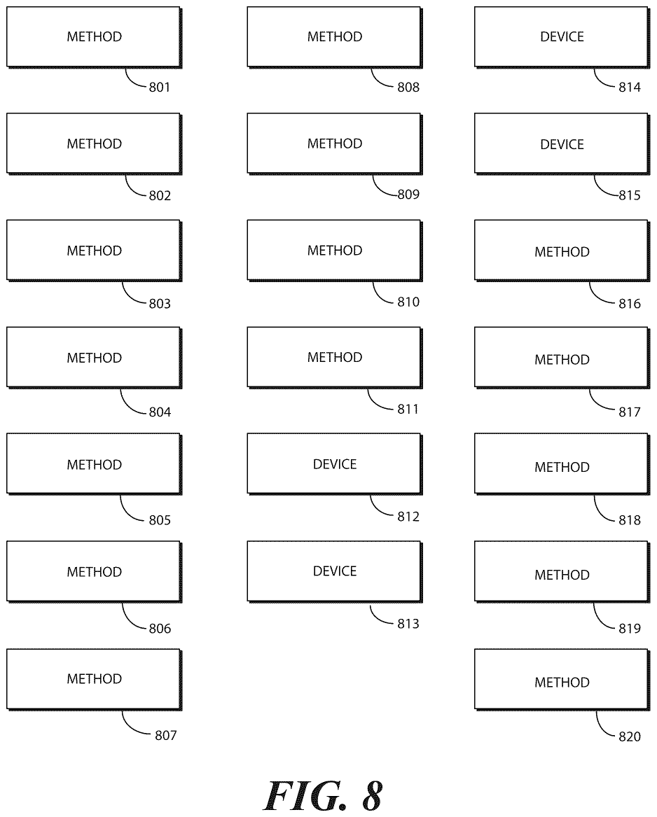

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments. Thus, the embodiments are shown as labeled boxes.

At 801, a method in an electronic device comprises determining, by one or more processors using a communication device, at least two locations of at least two companion electronic devices within an environment of the electronic device using at least one Bluetooth low energy (BLE) channel sounding measurement for each companion electronic device of the at least two companion electronic devices. At 801, the method comprises performing, using one or more sensors, at least one supplemental measurement for each companion electronic device of the at least two companion electronic devices. At 801, the method comprises selecting, by the one or more processors, a closest, user-facing companion electronic device of the at least two companion electronic devices using a combination of the at least one BLE channel sounding measurement and the at least one supplemental measurement. At 801, the method comprises causing, by the one or more processors, the communication device to deliver content to the closest, user-facing companion electronic device.

At 802, the at least two companion electronic devices of 801 comprise BLE sounding enabled companion electronic devices. At 803, the at least one supplemental measurement of 801 comprises at least one received signal strength indication (RSSI) measurement of one or more communication signals received by the communication device from the at least two companion electronic devices.

At 804, the selecting the closest, user-facing companion electronic device of 803 comprises choosing a companion electronic device of the at least two companion electronic devices having a lesser path loss, as indicated by the RSSI measurement, than another companion electronic device of the at least two companion electronic devices.

At 805, a path loss of the companion electronic device of 804 is at least ten decibels lower than another path loss of another companion electronic device. At 806, the at least one supplemental measurement of 803 comprises a body detection measurement detecting whether the electronic device is experiencing a bodily worn condition.

At 807, the method further comprises adjusting the RSSI measurement of 806 when the electronic device is experiencing a bodily worn condition. At 808, the at least one supplemental measurement of 803 comprises a motion measurement detecting whether the electronic device is in motion within the environment.

At 809, the method of 808 further comprises filtering, by the one or more processors, one or both of the at least one BLE channel sounding measurement or the at least one supplemental measurement of 808 when the electronic device is in motion within the environment.

At 810, the method of 801 further comprises determining, prior to the causing of 801, whether a user profile associated with the content is active on the closest, user-facing companion electronic device, wherein causing delivery of the content occurs only when the user profile associated with the content is active on the closest, user-facing companion electronic device.

At 811, the closest, user-facing companion electronic device of 801 comprises a display, the content comprises pictorial or video content, and audio content associated with the pictorial or video content is delivered to a companion electronic device other than the closest, user-facing companion electronic device.

At 812, an electronic device comprises a Bluetooth low energy (BLE) channel sounding enabled communication device and one or more processors operable with the BLE channel sounding enabled communication device. At 812, the one or more processors cause the BLE channel sounding enabled communication device to detect at least a first companion electronic device and a second companion electronic device operating within an environment of the electronic device and select a content reception companion electronic device from the first companion electronic device and the second companion electronic device by determining which of the first companion electronic device or the second companion electronic device has associated therewith a lesser received signal strength indication (RSSI).

At 813, the one or more processors of 812 further cause the BLE channel sounding enabled communication device to transmit content to the content reception companion electronic device in response to selecting the content reception companion electronic device. At 814, the detection of the first companion electronic device and the second companion electronic device of 812 occurs in response to the electronic device receiving the content from a remote electronic device across a network.

At 815, a method in an electronic device comprises identifying, by one or more processors using a communication device, a plurality of companion electronic devices operating within an environment of the electronic device. At 815, the method comprises determining, by the one or more processors using the communication device, at least one closer companion electronic device of the plurality of the companion electronic devices using a Bluetooth low energy (BLE) channel sounding process.

At 815, the method comprises determining, by the one or more processors using the communication device, whether the at least one closer companion electronic device of the plurality of companion electronic devices is a front-facing companion electronic device using a received signal strength indication (RSSI) process. At 815, the method comprises, when the at least one closer companion electronic device of the plurality of companion electronic devices is a front-facing companion electronic device, causing, by the one or more processors, the communication device to deliver content to the front-facing companion electronic device.

At 816, the causing of 815 only occurs when the front-facing companion electronic device is a closest, front-facing companion electronic device of the plurality of companion electronic devices. At 817, the causing of 815 only occurs when a user profile associated with the content is active on the front-facing companion electronic device.

At 818, the method of 817 further comprises determining, using one or more sensors of the electronic device, whether the electronic device is in a bodily worn condition, and when the electronic device is in a bodily worn condition, adjusting calculations of the RSSI process used to determine whether the at least one closer companion electronic device of the plurality of companion electronic devices is the front-facing companion electronic device.

At 819, the method of 818 further comprises determining, using the one or more sensors of the electronic device, whether the electronic device is moving, and when the electronic device is moving, filtering, by the one or more processors, the calculations of the RSSI process. At 820, the method of 818 further comprises causing, by the one or more processors using the communication device, the front-facing companion electronic device to wake from a sleep state and to deliver an alert indicating the content is being delivered to the front-facing companion electronic device.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in various embodiments of the electronic device described, the BLE channel sounding enabled communication device and the associated processors can be configured in multiple ways to enhance adaptability and functionality. In one embodiment, the BLE channel sounding enabled communication device may be integrated into a compact, wearable form factor, such as a smartwatch or fitness tracker, allowing for seamless communication with nearby companion electronic devices. This configuration is particularly advantageous for users who require mobility and convenience.

In another embodiment, the BLE communication device could be housed within a stationary hub, such as a smart home controller, which manages multiple companion devices within a residential environment. This setup is ideal for users looking to centralize control over various smart devices.

The processors in these embodiments can be designed to support advanced algorithms for determining the optimal content reception companion device based on real-time RSSI measurements, ensuring efficient content delivery. Additionally, the processors may be equipped with machine learning capabilities to adapt to user preferences over time, further enhancing the user experience.

The BLE channel sounding enabled communication device can also be configured to operate in environments with varying signal interference levels, employing adaptive filtering techniques to maintain reliable communication. These embodiments demonstrate the versatility of the system, accommodating different user needs and environmental conditions while remaining within the functional scope of the system.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
determining, by one or more processors using a communication device, at least two locations of at least two companion electronic devices within an environment of the electronic device using at least one Bluetooth low energy (BLE) channel sounding measurement for each companion electronic device of the at least two companion electronic devices;
performing, using one or more sensors, at least one supplemental measurement for the each companion electronic device of the at least two companion electronic devices;
selecting, by the one or more processors, a closest, user facing companion electronic device of the at least two companion electronic devices using a combination of the at least one BLE channel sounding measurement and the at least one supplemental measurement; and
causing, by the one or more processors, the communication device to deliver content to the closest, user facing companion electronic device.

2. The method of claim 1, wherein the at least two companion electronic devices comprise BLE sounding enabled companion electronic devices.

3. The method of claim 1, wherein the at least one supplemental measurement comprises at least one received signal strength indication (RSSI) measurement of one or more communication signals received by the communication device from the at least two companion electronic devices.

4. The method of claim 3, wherein the selecting the closest, user facing companion electronic device comprises choosing a companion electronic device of the at least two companion electronic devices having a lesser path loss, as indicated by the RSSI measurement, than another companion electronic device of the at least two companion electronic devices.

5. The method of claim 4, wherein a path loss of the companion electronic device is at least ten decibels lower than another path loss of the another companion electronic device.

6. The method of claim 3, wherein the at least one supplemental measurement comprises a body detection measurement detecting whether the electronic device is experiencing a bodily worn condition.

7. The method of claim 6, further comprising adjusting the RSSI measurement when the electronic device is experiencing a bodily worn condition.

8. The method of claim 3, wherein the at least one supplemental measurement comprises a motion measurement detecting whether the electronic device is in motion within the environment.

9. The method of claim 8, further comprising filtering, by the one or more processors, one or both of the at least one BLE channel sounding measurement or the at least one supplemental measurement when the electronic device is in motion within the environment.

10. The method of claim 1, further comprising determining, prior the causing, to whether a user profile associated with the content is active on the closest, user facing companion electronic device, wherein causing delivery of the content occurs only when the user profile associated with the content is active on the closest, user facing companion electronic device.

11. The method of claim 1, wherein:
the closest, user facing companion electronic device comprises a display;
the content comprises pictorial or video content; and
audio content associated with the pictorial or video content is delivered to a companion electronic device other than the closest, user facing companion electronic device.

12. An electronic device, comprising:
a Bluetooth low energy (BLE) channel sounding enabled communication device; and
one or more processors operable with the BLE channel sounding enabled communication device;
wherein the one or more processors cause the BLE channel sounding enabled communication device to detect at least a first companion electronic device and a second companion electronic device operating within an environment of the electronic device and select a content reception companion electronic device from the first companion electronic device and the second companion electronic device by determining which of the first companion electronic device or the second companion electronic device has associated therewith a lesser received signal strength indication (RSSI).

13. The electronic device of claim 12, the one or more processors are further configured to cause the BLE channel sounding enabled communication device to transmit content to the content reception companion electronic device in response to selecting the content reception companion electronic device.

14. The electronic device of claim 13, wherein detection of the first companion electronic device and the second companion electronic device occurs in response to the electronic device receiving the content from a remote electronic device across a network.

15. A method in an electronic device, the method comprising:
identifying, by one or more processors using a communication device, a plurality of companion electronic devices operating within an environment of the electronic device;
determining, by the one or more processors using the communication device, at least one closer companion electronic device of the plurality of the companion electronic devices using a Bluetooth low energy (BLE) channel sounding process;
determining, by the one or more processors using the communication device, whether the at least one closer companion electronic device of the plurality of companion electronic devices is a front facing companion electronic device using a received signal strength indication (RSSI) process; and
when the at least one closer companion electronic device of the plurality of companion electronic devices is a front facing companion electronic device, causing, by the one or more processors, the communication device to deliver content to the front facing companion electronic device.

16. The method of claim 15, wherein the causing only occurs when the front facing companion electronic device is a closest, front facing companion electronic device of the plurality of companion electronic devices.

17. The method of claim 15, wherein the causing only occurs when a user profile associated with the content is active on the front facing companion electronic device.

18. The method of claim 17, further comprising:
determining, using one or more sensors of the electronic device, whether the electronic device is in a bodily worn condition; and
when the electronic device is in a bodily worn condition, adjusting calculations of the RSSI process used to determine whether the at least one closer companion electronic device of the plurality of companion electronic devices is the front facing companion electronic device.

19. The method of claim 18, further comprising:
determining, using the one or more sensors of the electronic device, whether the electronic device is moving; and
when the electronic device is moving, filtering, by the one or more processors, the calculations of the RSSI process.

20. The method of claim 18, further comprising causing, by the one or more processors using the communication device, the front facing companion electronic device to wake from a sleep state and to deliver an alert indicating the content is being delivered to the front facing companion electronic device.
